(19) United States
(12) Patent Application Publication
(10) Pub. No.: US 2008/0060567 A1
(43) Pub. Date: Mar. 13, 2008

(54) Buckle punch

(76) Inventors: Ronald Aniceto, Hawthorne, NJ (US); Amy Jane Reda, Piscataway, NJ (US)

Correspondence Address: SOFER & HAROUN LLP., 317 MADISON AVENUE, SUITE 910, NEW YORK, NY, 10017, US

(21) Appl. No.: 11/519,211

(22) Filed: Sep. 11, 2006

(51) Int. Cl. B26D 5/08

(52) U.S. Cl. 112/475.01; 83/588; 83/633; 83/684

(57) ABSTRACT

A punch for making a decorative buckle design on a sheet medium. The punch includes a body formed with a fissure for receiving the sheet media, a cutter axially movable within the body and a die secured in said body configured to engage with the cutter. The cutter cuts out at least two flaps in the sheet medium, each flap is connected to a central supporting column.

### FIELD OF THE INVENTION

The present invention relates to a punch device. More particularly, the present invention relates to a punch device for making a buckle shaped perforation in a sheet medium.

### BACKGROUND OF THE INVENTION

In the field of decorative crafts such as scrap booking, one desired effect is to adorn a sheet medium or piece of craft paper with a ribbon medium, such as a thin strip of ribbon, fabric, or paper.

In the prior art, a craftsman would need to carefully attach a ribbon medium to a sheet medium in a decorative fashion by using such techniques including adhesives, staples, or threading through holes punched by hand, all of which require a great deal of skill to make a consistently neat decorative effect. Furthermore, the use of glue, tape, or staples, also decreases the aesthetic appeal of the final result.

### SUMMARY OF THE INVENTION

The present invention provides a simple way to attach a ribbon medium to a sheet medium in a decorative fashion without using such techniques as adhesives, staples, or threading through holes punched by hand. Likewise, the present invention requires no consumables such as glue, tape, or staples, and can be reused an unlimited number of times.

It is therefore an object of the present invention to provide a means for securing a ribbon medium through a sheet medium by creating a buckle in the sheet medium. The buckle is formed by two flaps cutout of the sheet medium. The flaps are attached to the sheet medium by a central supporting column, each flap with at least one hollow interior portion. A ribbon is affixed to the sheet medium by threading it through the hollow interior portions.

It is a further object of the present invention to provide a punch device for creating such buckles including a seat body formed with a horizontal fissure and a vertical chamber communicated with the fissure. A cutting block is disposed in the chamber. One face of the cutting block is disposed with a cutter, while the other face of the cutting block is disposed with a channel passing through the cutting block. A pressing lever is pivotally disposed in the channel of the cutting block. A housing covers the seat body and is formed with a window for a pressing section of the pressing lever to extend therethrough. In use, a paper or a sheet is pushed into the fissure of the seat body and then the pressing section of the pressing lever is depressed to force the cutting block downward with the die punching the sheet medium placed in the fissure. Therefore, a buckle is formed in the sheet medium, through which a ribbon medium can be threaded.

It is a further object of the present invention to provide the above punch device, in which a resilient member is fitted under the cutting block in the chamber of the seat body. After the cutting block is released from the pressing force of the pressing lever, the resilient member serves to restore the cutting block to its home position.

It is still a further object of the present invention to provide the above punch device in which the cutting block is replaceably placed in the seat body, whereby the cutting block can be easily replaced by another cutting block to create different buckle designs.

### BRIEF DESCRIPTION OF THE DRAWINGS

The present invention can be best understood through the following description and accompanying drawings, wherein:

FIG. 1 is a perspective exploded view of the present invention, in accordance with one embodiment of the present invention;

FIG. 2 is a perspective assembled view of the present invention, in accordance with one embodiment of the present invention;

FIG. 3 is a front sectional view of the present invention, wherein the pressing lever is not pressed downward, in accordance with one embodiment of the present invention;

FIG. 4 is a side sectional view of the present invention, wherein the pressing lever is not pressed downward, in accordance with one embodiment of the present invention;

FIG. 5 is a side sectional view according to FIG. 4, wherein the pressing lever is pressed downward to punch the paper or the sheet, in accordance with one embodiment of the present invention;

FIG. 6 is a top-down view of the underside of cutting block 20, in accordance with one embodiment of the present invention;

FIG. 7 is an overhead view of female die 14, in accordance with one embodiment of the present invention;

FIG. 8 is a top-down view of the underside of cutting block 20, in accordance with another embodiment of the present invention;

FIG. 9 is an overhead view of female die 14, in accordance with another embodiment of the present invention;

FIG. 10 is an overhead view of the sheet medium after use of the present invention, in accordance with one embodiment of the present invention;

FIG. 11 is an overhead view of the sheet medium after use by an alternate embodiment of the present invention, in accordance with one embodiment of the present invention;

FIG. 12 is an overhead view of the sheet medium depicting how a ribbon can be threaded through the buckle formed in the sheet medium for decorative effect, in accordance with one embodiment of the present invention; and

FIG. 13 is an overhead view of the sheet medium depicting how a ribbon can be threaded through the buckle formed in the sheet medium for decorative effect, in accordance with another embodiment of the present invention.

### DETAILED DESCRIPTION OF THE PREFERRED EMBODIMENT

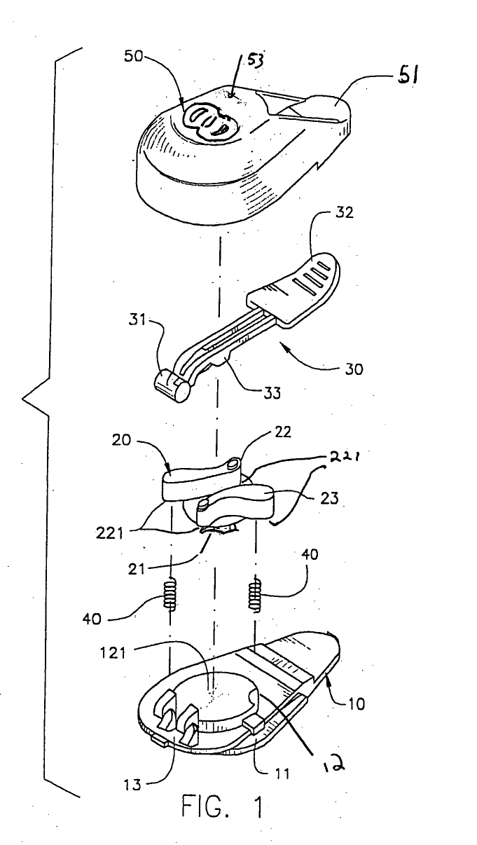

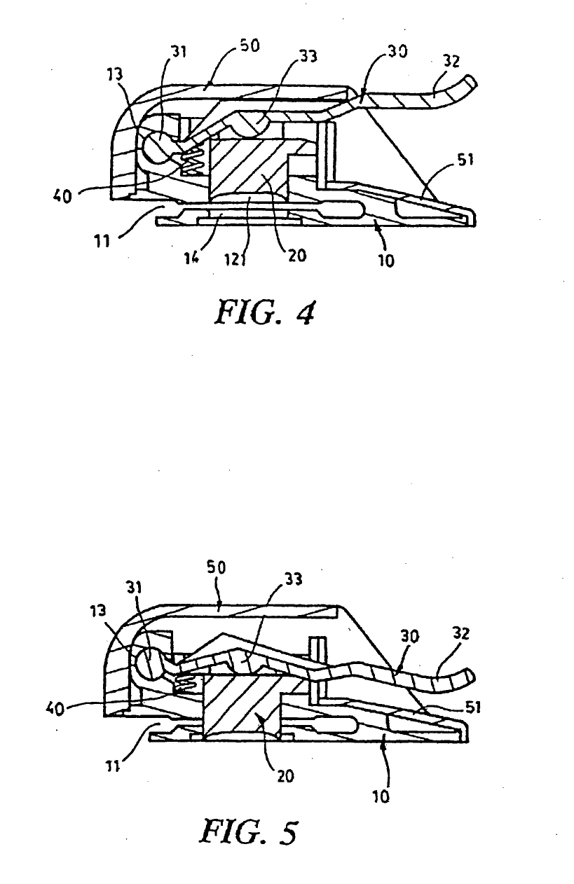

Please refer to FIGS. 1 to 5. The punch device of the present invention includes a seat body 10 formed with a horizontal fissure 11 at one end and a vertical chamber 12. The bottom of the chamber 12 is formed with an opening 121 communicated with the fissure 11. An insertion cavity 13 is disposed on seat body 10 in front of opening 121. The bottom of the seat body 10 is formed with a female die 14 communicated with the fissure 11 opposite to the opening 121.

A cutting block 20 is disposed on the seat body 10. One face of the cutting block 20 facing the fissure 11 is disposed with a solid cutter 21 in the shape of an outline of a geometric or other symmetrical shape. The other face of the cutting block 20 is disposed with a channel passing through the cutting block 20, forming walls 22 and 23.

The cutting block 20 is disposed with a projection 23 corresponding to the extension 122 to be fitted therein. A recess 221 is created on the underside of each of the protrusions of walls 22 and 23 for the purpose of engaging with resilient member 40, as described below.

A pressing lever 30 is disposed in the cutting block 20. One end of the pressing lever 30 is disposed with a pivot shaft 31 for rotatably inserting in the insertion cavity 13 of the seat body 10, whereby the pressing lever 30 is pivotally disposed on the seat body 10.

The other end of the pressing lever 30 is disposed with an upward bent pressing section 32. In addition, the pressing lever 30 is formed with a protuberance 33 extending in a direction reverse to that of the pressing section 32 for fitting in the recesses 221 of the cutting block 20.

At least one resilient member 40 is fitted into recess 221. As illustrated in FIG. 1 preferably two resilient members 40 where at least one resilient member 40 comprises first and second oppositely disposed springs adjacent to said die. The first resilient member 40 is disposed along a second axis and the second resilient member 40 disposed along a third axis, the third axis spaced apart from the first solid cutter 21 axis and the second resilient member 40 axis.

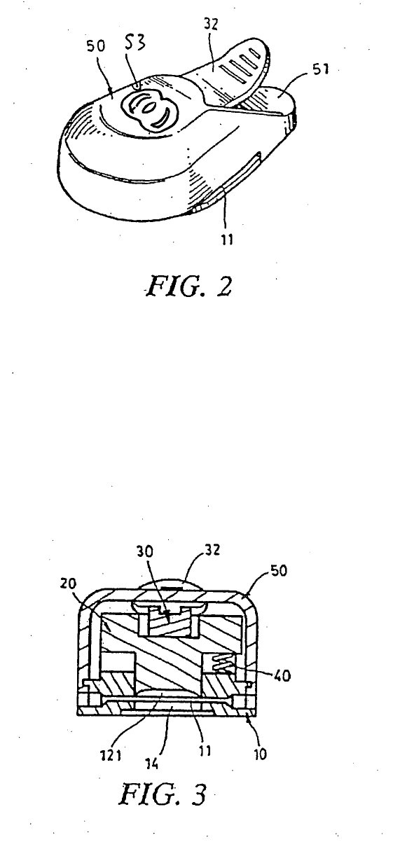

A housing 50 covers the seat body 10 and is formed with a window 51, whereby the pressing section 32 of the pressing lever 30 can extends through the window 51 out of the housing 50. As illustrated in FIGS. 1 and 2, housing 50 preferably maintains an indication 53 corresponding to the shape of cutter 21.

In use, a paper or a sheet 60 is horizontally placed in the fissure 11 of the seat body 10 and pushed inward to a true position. Fissure 11 is maintained perpendicular to the movement axis of cutter 21. Then the pressing section 32 of the pressing lever 30 is pivotally depressed about the pivot shaft 31, whereby the protuberance 33 of the pressing lever 30 is moved downward to exert a force onto the cutting block 20. Accordingly, the cutting block 20 is forced downward with the cutter 21 passing through the opening 121 of the chamber 12 to punch the paper or the sheet placed in the fissure 11 through the correspondingly shaped die 14. Thus, a perforation is created in the sheet medium as defined by the periphery of the cutter 21 which engages with the female die 14 as shown in FIG. 5. The resilient member 40 serves to restore the cutting block 20 to its home position. At this time, the pressing section 32 of the pressing lever 30 is moved upward along with the cutting block 20 to its home position. The above operation can be repeatedly performed to create the same partial cutout.

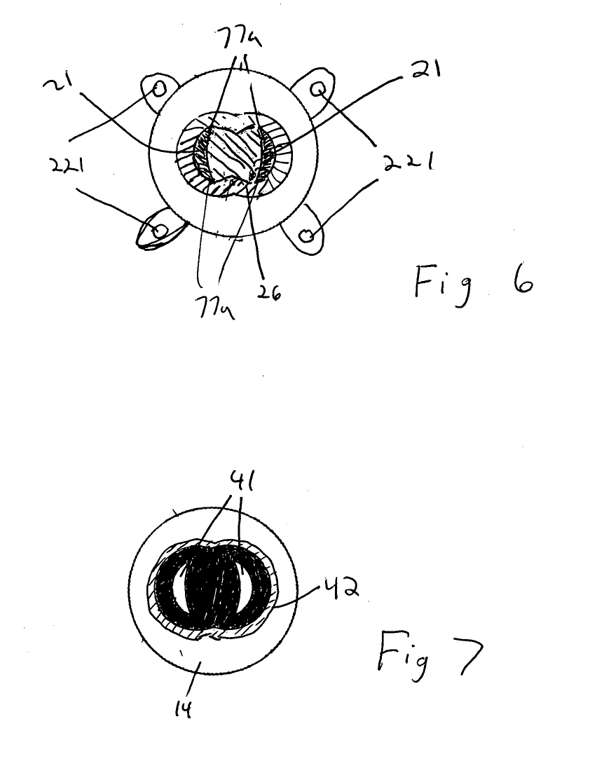

As shown in FIG. 6, cutter 21 is ideally a sharpened tapered metal blade, shaped as a three dimensional projection of the outline to be created. In one embodiment of the present invention, cutter 21 is tapered such that its highest (deepest cutting) points 77a are furthest away from the horizontal, or width axis of the cutter at points closest to and furthest from the pressing section 32 of the center of cutter 21 along the long or length axis (in line with lever 30). In an alternate embodiment, the edge on cutter 21 can be serrated. Both approaches are designed to make the perforations for the cutouts as cleanly as possible, without any wrinkling or warping in the sheet medium 60. Cutter 21 may also be surrounded by a rubber or plastic insert 26, which is inserted into a recess in the center of the underside of cutting block 20. Insert 26 is used to make the perforations as cleanly as possible, without any wrinkling or warping of the sheet medium.

In FIG. 7, die 14 is designed to engage with cutter 21 and is shaped as a female version of cutter 21. Die 14 is also equipped with a series of holes 41 corresponding to cutter 21, through which the portions of the sheet medium which form holes 81 may be punched. A rubber or similar insert 42 may be placed into a recesses of die 14 around the cutter receiving portion to block all but the deepest portions of cutter 21 from entering die 14. This ensures that the perforations are made as precisely as possible.

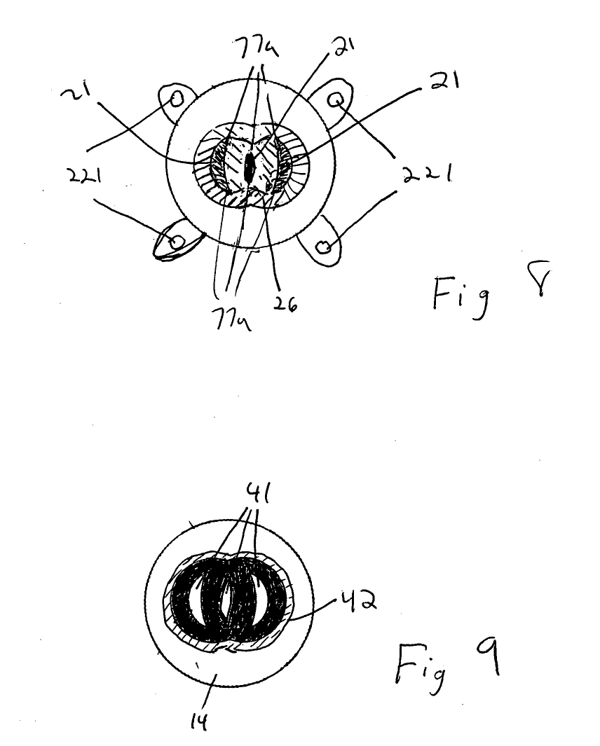

In another embodiment of the present invention, FIGS. 8 and 9 depict an alternate arrangement for cutter 21 and die 14 respectively, where cutter 21 maintains an additional center cutter 21a and die 14 maintains an additional center cutter receiving hole 41a.

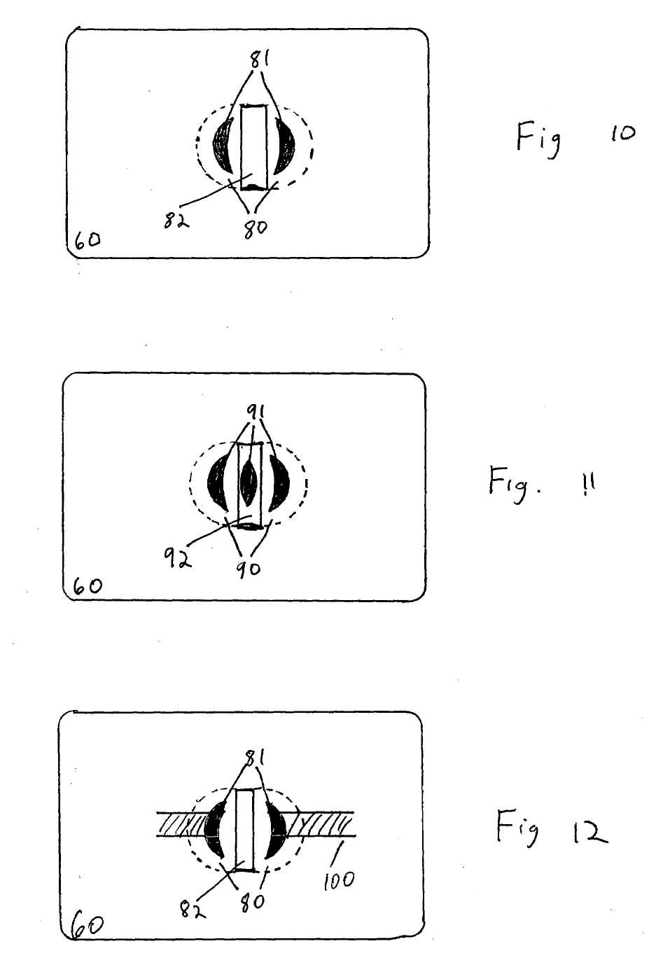

Turning now to the cutting of sheet media 60 by way of punch device 10, in one embodiment of the present invention, FIG. 10 illustrates a punched sheet media according to a die 14 and cutter 21 arrangement from FIGS. 6 and 7. Here flaps 80 are formed in sheet medium 60 by cutting along a portion of an outline, leaving flaps 80 attached to a central support column 82. In each of flaps 80, a hole 81 has been created by punching a portion of the paper with cutter 21 through holes in die 14. Both the flaps and the holes may be in any shape, but for the purposes of illustration FIG. 10 simply shows smooth curved edges for flaps 80 and centralo support column.

In another embodiment of the present invention, FIG. 11 depicts an alternate sheet media 60 punched according to the die 14 and cutter 21 arrangement from FIGS. 8 and 9 in which support column 92 contains an extra hole 91 in addition to the holes in flaps 90. Extra hole 91 is formed from the punching of central cutter portion 21a moving through center hole 41a in die 14.

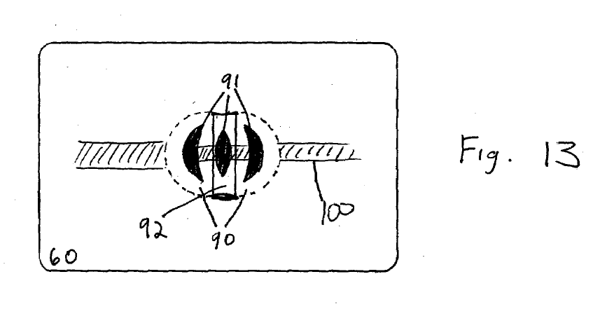

In one embodiment of the present invention, FIG. 12 depicts the invention in which ribbon medium 100 is threaded through holes 81 as formed by die 14 and cutter 21 arrangement from FIGS. 6 and 7, thereby attaching to sheet medium 60. While ribbon medium 100 need only be thread through at least one hole, ideally all holes 81 should be used to for the most secure attachment. Ribbon medium 100 can be constructed of any material, such as paper, ribbon, fabric, foil, plastic, or any like material with the same dimensions. Sheet medium 60 can similarly be made of paper, fabric, plastic, foil, or the like.

In another embodiment of the present invention as illustrated in FIG. 13 ribbon medium 100 is threaded through holes 91 as formed by die 14 and cutter 21 arrangement from FIGS. 8 and 9, thereby attaching to sheet medium 60. Again, while ribbon medium 100 need only be thread through at least one hole, ideally all holes 91 should be used to for the most secure attachment.

Additionally in either of these arrangements ribbon 100 may be threaded over flaps 80/90 and under central column 82/92 as shown in FIG. 12, or under flaps 80/90 and over central column 82/92 as shown in FIG. 13.

It is to be understood that the above description and drawings are only used for illustrating one embodiment of the present invention, not intended to limit the scope thereof. Any variation and derivation from the above description and drawings should be included in the scope of the present invention.

1. A punch for making a decorative buckle design on a sheet medium, said punch comprising:
a body formed with a fissure for receiving said sheet media;
a cutter axially movable within said body;
a die secured in said body configured to engage with said cutter; and
wherein said cutter cuts out at least two flaps in the sheet medium, each flap connected to a central supporting column.

2. A punch as defined by claim 1, wherein said at least two flaps each contain at least one hollow interior portion.

3. A punch as defined by claim 1, further comprising a pressing lever coupled with a cutting block affixed to said cutter.

4. A method for securing a ribbon medium to a sheet medium using the punch as defined by claim 2, said method comprising:
punching said sheet medium with said punch, thereby creating said at least two flaps with said at least one hollow interior portion;
threading said ribbon medium through said at least one hollow interior portion.
